(19) United States
(12) Patent Application Publication
(10) Pub. No.: US 2025/0001794 A1
(43) Pub. Date: Jan. 2, 2025

(54) SECURITY DEVICE HAVING MACHINE-READABLE FEATURE REGIONS, VALUE DOCUMENT AND TESTING METHOD

(71) Applicant: Giesecke+Devrient Currency Technology GmbH, Munich (DE)

(72) Inventors: Matthias PFEIFFER, Munich (DE); Gerhard HAMPP, Munich (DE); Alexander HUBER, Gmund (DE)

(21) Appl. No.: 18/751,881

(22) Filed: Jun. 24, 2024

(30) Foreign Application Priority Data
Jun. 29, 2023 (DE) 102023117185.2

(51) Int. Cl. B42D 25/36; B42D 25/355

(52) U.S. Cl. CPC B42D 25/36; B42D 25/355; B42P 2201/04

(57) ABSTRACT

A security device has a foil carrier having opposing main surfaces and has, arranged on the opposing main surfaces of the foil carrier, two machine-readable feature regions that include in each case an IR-absorbing substance, at least one of the machine-readable feature regions including an IR-absorbing substance having an absorption maximum between 800 nm and 1000 nm.

### BACKGROUND

The present invention relates to a security device having machine-readable feature regions having an IR-absorbing substance. The present invention also relates to a value document having such a security device, as well as a method for testing such a security device.

For protection, data carriers, such as value or identification documents, but also other valuable objects, such as branded articles, are often furnished with security elements that permit the authenticity of the data carriers to be tested and that simultaneously serve as protection against unauthorized reproduction.

To facilitate an automatic authenticity test and, if applicable, an advanced sensor-based detection and processing of the data carriers furnished therewith, the security elements are often formed to be machine-readable. For this purpose, the security elements are furnished, for example, with infrared-(IR-) absorbing substances whose IR signature can, when testing the authenticity, be machine detected by an infrared sensor and assessed.

However, known security elements having IR-absorbing substances are often relatively easy to reconstruct and thus have only a minor safeguarding effect.

Proceeding from this, the object of the present invention is to specify a generic security device having increased counterfeit security. The present invention is also intended to provide a value document having such a security device and a method for testing such a security device.

Said object is solved by the features of the independent claims. Developments of the present invention are the subject of the dependent claims.

### SUMMARY

The present invention includes a security device having a foil carrier having opposing main surfaces and having two machine-readable feature regions arranged on the opposing main surfaces of the foil carrier.

The machine-readable feature regions include in each case an IR-absorbing substance, at least one of the machine-readable feature regions including an IR-absorbing substance having an absorption maximum between 800 nm and 1000 nm.

In the following, for the sake of simplicity, IR-absorbing substances are also often referred to as IR substances or IR materials for short. As explained in greater detail below, IR-absorbed substances typically display an absorption behavior having a relatively shallow absorption minimum in the wavelength range between 800 nm and 1000 nm. Accordingly, the IR remission of such IR substances displays a relatively shallow maximum in the wavelength range from 800 nm to 1000 nm and then decreases again slowly toward larger wavelengths.

Thus, the IR substances used according to the present invention, having an absorption maximum between 800 nm and 1000 nm and a corresponding minimum in remission, display an atypical absorption behavior, and as a result, can be reliably distinguished from conventional IR substances in an authenticity test. Since IR substances having atypical absorption behavior are much more difficult for counterfeiters to obtain than conventional IR substances, the barrier to counterfeiting increases significantly.

In addition, since machine-readable feature regions having an IR-absorbing substance are present on both opposing sides of the foil carrier, the security device can be tested from both sides in an authenticity test, and the presence of an IR signal can be compared with an expected signal to assess the authenticity of the security device.

In one advantageous embodiment, both machine-readable feature regions include an IR substance having an absorption maximum between 800 nm and 1000 nm.

In another, likewise advantageous embodiment, only one of the machine-readable feature regions includes an IR substance having an absorption maximum between 800 nm and 1000 nm, while the other of the machine-readable feature regions includes an IR substance without an absorption maximum between 800 nm and 1000 nm. The latter IR substance is especially a conventional IR substance having typical absorption behavior, that is, a shallow absorption minimum in the mentioned wavelength range.

In one particularly advantageous embodiment, the IR substance that is present in at least one of the feature regions and has atypical absorption behavior has a significantly higher absorption at a wavelength of 950 nm than at a wavelength of 850 nm, especially an at least 3%, at least 5%, or even at least 8% higher absorption.

The absorption maximum of the IR substance having atypical absorption behavior is especially between 940 nm and 980 nm.

It is advantageously provided that the IR substance that is present in at least one of the feature regions and has atypical absorption behavior has a remission of 60% or less in the wavelength range from 800 nm to 1000 nm.

On the security device, in projection, the two machine-readable feature regions advantageously overlap one another at least in some regions. This enables the two feature regions to co-act in the overlap region and, in doing so, to form, for example, a machine-readable see-through-register or a shared machine-readable code.

In preferred embodiments, the two machine-readable feature regions form in each case a machine-readable code, the code especially being able to be formed by the shape and size of the machine-readable feature regions and/or by the shape and size of gaps in the machine-readable feature regions. The two machine-readable feature regions together particularly advantageously form an additional machine-readable code whose presence can be assessed as an authenticating feature. In this way, the security device can provide a plurality of coding possibilities.

Furthermore, also the specifically chosen combination of the IR substances of the two feature regions can serve as a code that characterizes a security device or a value document furnished therewith.

According to one advantageous embodiment, the two machine-readable feature regions are in each case present contiguously on the foil carrier. Also in contiguous feature regions, a location dependence of the IR signal can result, for example, from different concentrations of the IR substance in some regions, or from the embedding of the security device in a target document. For example, a window security thread can be furnished contiguously on both sides with machine-readable feature regions and be partially embedded in the paper substrate of a banknote in such a way that, when measuring the front, an IR remission signal is detectable only in window regions but not in the intermediate web regions of the paper substrate. Analogously, when measuring the reverse, an IR remission signal can be detectable only in regions lying opposite web regions in the front, but not regions lying opposite window regions in the front, as described in greater detail below.

Currently, however, it is particularly preferred that one or both of the machine-readable feature regions are present structured in the form of patterns, characters or a code. A structured formation of the feature regions especially permits easy production of spatial codes, such as a barcode.

In one development of the present invention, at least one of the machine-readable feature regions is covered in some regions with paper webs or an IR blocker. Paper webs or IR blocks can also be part of the target document in which the security device according to the present invention is embedded.

The security device is advantageously a security element, especially a security thread or a security band.

Here, the present invention also includes a value document, especially a banknote, having such a security element, the security element being, in advantageous embodiments, at least partially embedded in the interior of the value document.

In another, likewise advantageous development, the security device itself is a value document, especially a banknote.

Finally, the present invention also includes a method for testing a security device of the kind described, in which the security device is impinged on with IR radiation, the IR radiation remitted by the security device is measured as an IR signal and it is determined from the measured IR signal whether the security device includes a feature region having an IR-absorbing substance having an absorption maximum between 800 nm and 1000 nm.

In the method, advantageously, both the front and the reverse of the security device are impinged on with the IR radiation and the IR radiation remitted by the security device is measured in each case as an IR signal.

Here, it can advantageously be determined whether the security device includes two feature regions having an IR substance having atypical absorption behavior or one feature region having an IR substance having atypical absorption behavior and one feature region having an IR substance having typical absorption behavior.

### BRIEF DESCRIPTION OF THE DRAWINGS

Further exemplary embodiments and advantages of the present invention are explained below by reference to the drawings, in which a depiction to scale and proportion was dispensed with in order to improve their clarity. Including the following:

FIG. 1 shows schematically, a banknote having a window security thread according to the present invention, in cross section,

FIGS. 2A-2B show schematically, the appearance, detected with an IR sensor, of the banknote in FIG. 1, in each case in top view, in (A) from the front and in (B) from the reverse,

FIG. 3 shows schematically, the IR remission of an IR substance having atypical absorption behavior compared with the IR remission of two IR substances having typical absorption behavior,

FIG. 4 shows a modification of the exemplary embodiment in FIG. 2, in which the window security thread comprises only in its bottom-side coating an IR substance having atypical absorption behavior,

FIGS. 5A-C shows a further exemplary embodiment of the present invention, (A) showing, schematically, a cross-sectional diagram of a banknote having a window security thread according to the present invention, and (B) and (C) showing, schematically, the appearance, detected with an IR sensor, of the banknote in top view from the front and reverse, respectively,

FIGS. 6A-C show in a diagram as in the description of FIGS. 5A-C, a further exemplary embodiment of the present invention in which both the upper coating and the lower coating of the window security thread is developed to be structured,

FIGS. 7A-C show in a diagram as in the description of FIGS. 5A-C, a further exemplary embodiment of the present invention, in which a security element according to the present invention is not embedded in a paper banknote, but rather constitutes part of a polymer banknote, and

FIGS. 8A-C shows in a diagram as in the description of FIGS. 5A-C, a further exemplary embodiment of the present invention, in which the security device is formed by a polymer banknote.

### DETAILED DESCRIPTION OF THE INVENTION

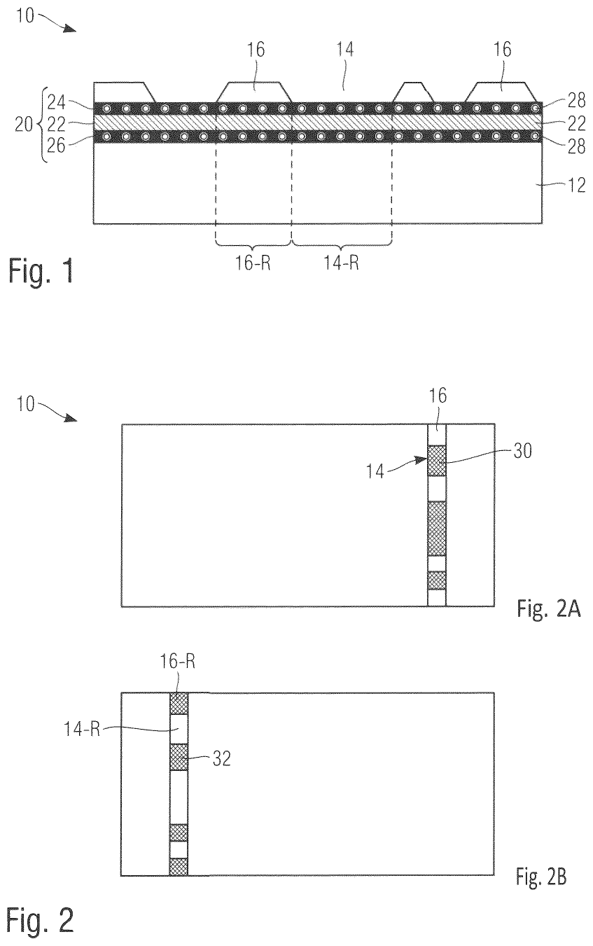

The invention will now be explained using the example of banknotes and security elements for banknotes. For this, FIG. 1 shows, schematically, a banknote 10 having a window security thread 20 according to the present invention, in cross section. Here, the window security thread 20 is partially embedded in the paper substrate 12 of the banknote 10, such that it emerges at the surface of the banknote in window regions 14, while it is embedded in the interior of the paper substrate 12 in the intermediate web regions 16.

The window security thread 20 includes a carrier foil 22 having opposing upper and lower main surfaces. As a distinctive feature, the two main surfaces are, in each case, to form machine-readable feature regions, furnished contiguously with a coating 24 or 26 that includes a special IR substance 28. The special IR substance 28 is an IR substance having atypical absorption behavior, namely a clear absorption maximum between 800 nm and 1000 nm.

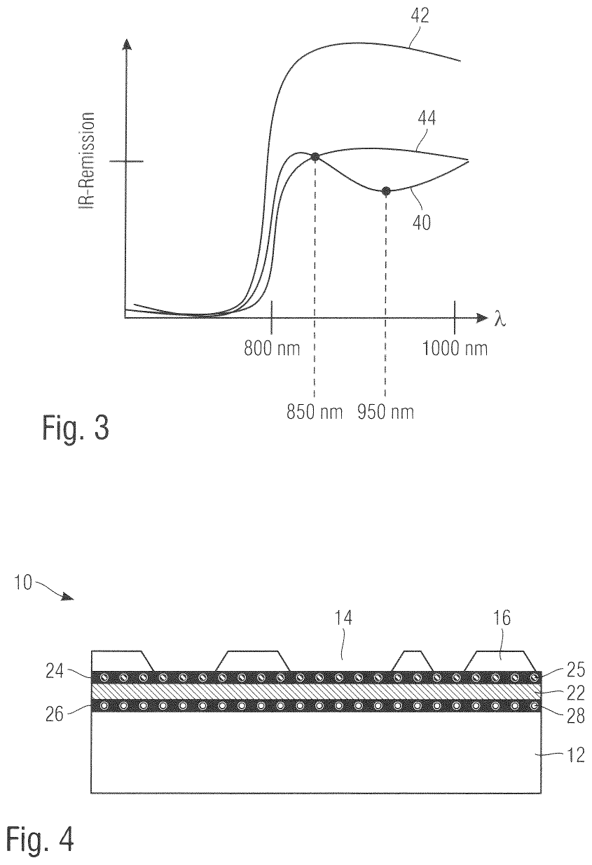

To explain in greater detail, FIG. 3 shows, schematically, the IR remission of the IR substance 28 used (remission curve 40) compared with the IR remission of two IR substances having typical absorption behavior (remission curves 42, 44). In the wavelength range between 800 nm and 1000 nm, the IR substances having typical absorption behavior comprise a normally shallow absorption minimum, such that the IR remission in said wavelength range accordingly displays a shallow maximum and decreases again slowly toward higher wavelengths. Here, the remission curve 42 stems from a first IR substance having relatively low absorption and thus high remission, while the remission curve 44 stems from a second IR substance having relatively high absorption and thus low remission.

In contrast to this, the special IR substance 28 displays an IR remission 40 having a high remission value at a wavelength of about 850 nm and a pronounced minimum at a wavelength of about 950 nm, before the remission increases again toward a wavelength of 1000 nm. Simultaneously, in the range from 800 to 1000 nm, the remission of the IR substance 28 is advantageously not over 60%.

One such special IR substance can be produced, for example, using an IR-absorbing printing ink that is commercially available from the company SICPA under the trade name SICPATALK® NFB.

It is understood that the exact progression of the remission curves and the precise magnitude of the IR remission depends on the specific IR substances used and FIG. 3 serves only schematically to illustrate the differences between a typical and an atypical absorption behavior.

FIG. 2 now shows, schematically, the appearance, detected with an IR sensor, of the banknote 10 in FIG. 1, in each case in top view, from the front (FIG. 2(a)) and the reverse (FIG. 2(b)). In the front-side measurement in FIG. 2(a), an IR signal 30 is measured in the window regions 14, while no IR signal is detected in the web regions 16. In the reverse-side measurement in FIG. 2(b), an inverted appearance results: there, an IR signal 32 is obtained in the regions 16-R that lie opposite the web regions 16 of the front, while no IR signal is obtained in the regions 14-R that lie opposite the window regions 14 of the front.

The mechanism of signal formation in remission measurement is not yet fully understood theoretically-since the reverse signal occurs in the geometric shape of the front web regions 16, the IR signal 32 measured on the reverse is, without wanting to be bound to a certain explanation, currently attributed to reflections of the IR radiation on the web regions 16 of the front.

When testing authenticity by means of an IR sensor, for example in a banknote processing machine, the banknote 10 can be tested from both the front and the reverse, and the presence of an IR signal having a suitable spatial distribution on both sides can be assessed as an indication of the authenticity or a lack of authenticity of the note. Furthermore, due to its atypical absorption behavior (remission curve 40), the IR substance 28 is easy to distinguish from other, conventional IR substances having typical absorption behavior (remission curves 42, 44).

FIG. 4 shows a modification of the exemplary embodiment in FIG. 2, in which the window security thread 20 comprises the special IR substance 28 having atypical absorption behavior only in its bottom-side coating 26, while the top-side coating 24 includes an IR substance 25 having typical absorption behavior, for example an IR substance having a shallow absorption minimum similar to the remission curves 42 and 44 in FIG. 3.

Also in this exemplary embodiment, when testing the authenticity by means of an IR sensor, the banknote 10 can be tested from both the front and the reverse, and the presence of an IR signal having a suitable spatial distribution and suitable absorption behavior on the two sides can be assessed as an indication of the authenticity or lack of authenticity of the note.

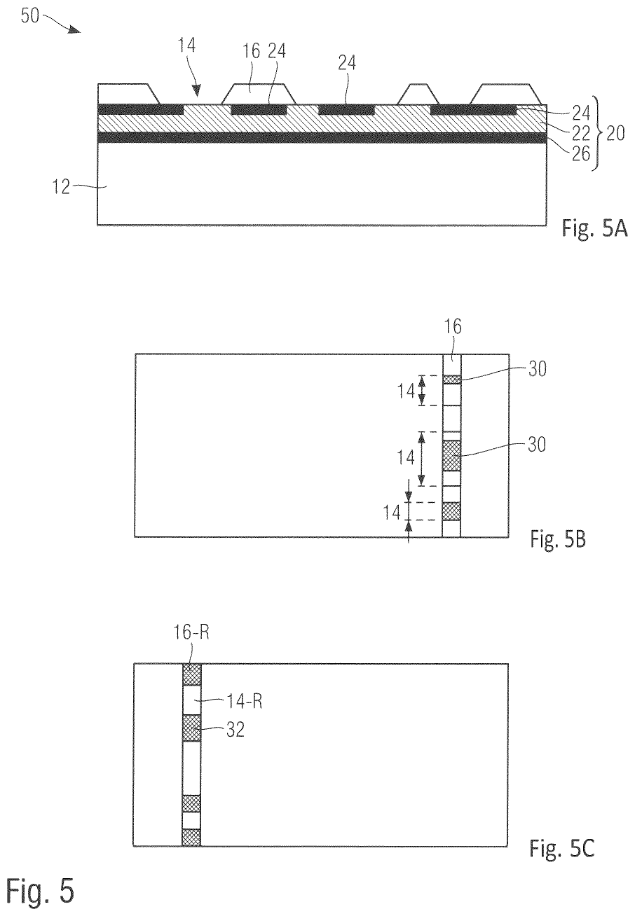

A further exemplary embodiment of the present invention is shown in FIG. 5, FIG. 5(a) showing a schematic cross-sectional diagram of a banknote 50 having a window security thread 20 according to the present invention, and FIGS. 5(b) and 5(c), schematically, the appearance, detected with an IR sensor, of the banknote in top view from the front (FIG. 5(b)) and the reverse (FIG. 5(c)).

Here, the feature regions, formed by the coatings 24, 26, of the window security thread 20 include in each case an IR substance, also when, for the sake of simplicity, said IR substance is no longer illustrated separately by symbols in FIG. 5 and the subsequent figures.

In the exemplary embodiment in FIG. 5, the upper coating 24 of the window security thread 20 is, in contrast to the embodiment in FIGS. 2 and 4, formed to be structured, that is, is present only in sub-regions of the thread surface, while the lower coating 26 is formed to be contiguous.

In the front-side measurement shown in FIG. 5(b), an IR signal 30 is obtained in the window regions 14 only at the sites at which coating material 24 is also present, while no IR signal is detected in the web regions 16, also if coating material is present there.

Since the lower coating 26 is formed to be contiguous, in the reverse-side measurement shown in FIG. 5(c), the same appearance results as in FIG. 2(b): an IR signal 32 is obtained in each case in the regions 16-R that lie opposite the web regions 16, while no IR signal is obtained in the regions 14-R that lie opposite the window regions 14.

At least one of the coatings 24, 26 includes an IR substance having atypical absorption behavior, that is, having an absorption maximum between 800 nm and 1000 nm, the other of the two coatings can also include an IR substance having typical absorption behavior. However, both coatings 24, 26 particularly preferably include an IR substance having atypical absorption behavior.

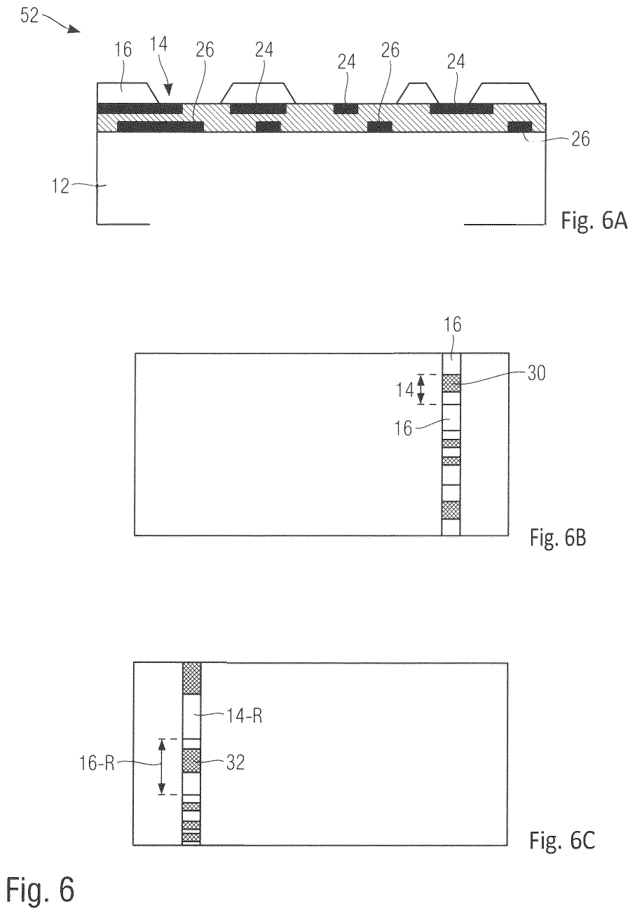

In the further exemplary embodiment of the present invention depicted in FIG. 6, FIG. 6(a) shows a cross-sectional view of a banknote 52 having a window security thread 20 according to the present invention, and FIGS. 6(b) and 6(c) show the appearance, detected with an IR sensor, of the banknote 52, in each case in schematic top view from the front (FIG. 6(b)) and the reverse (FIG. 6(c)) of the banknote.

In the exemplary embodiment in FIG. 6, both the upper coating 24 and the lower coating 26 of the window security thread 20 are formed to be structured. At least one, advantageously both coatings 24, 26, include an IR substance having atypical absorption behavior, that is, an absorption maximum between 800 nm and 1000 nm.

In the front measurement in FIG. 6(b), an IR signal 30 is obtained in the window regions 14 only at the sites at which coating material 24 is also present, while no IR signal is detected in the web regions 16, also when coating material is present there. In the reverse-side measurement in FIG. 6(c), in the regions 16-R lying opposite the web regions 16, an IR signal 32 is obtained only where coating material 26 is also present, while no IR signal is obtained in the regions 14-R lying opposite the window regions 14.

The characteristic spatial distributions of the IR signals 30 and 32 and the absorption behavior of the IR substances of the coatings 24, 26 (typical or atypical) permit a reliable authenticity test of the banknote 52.

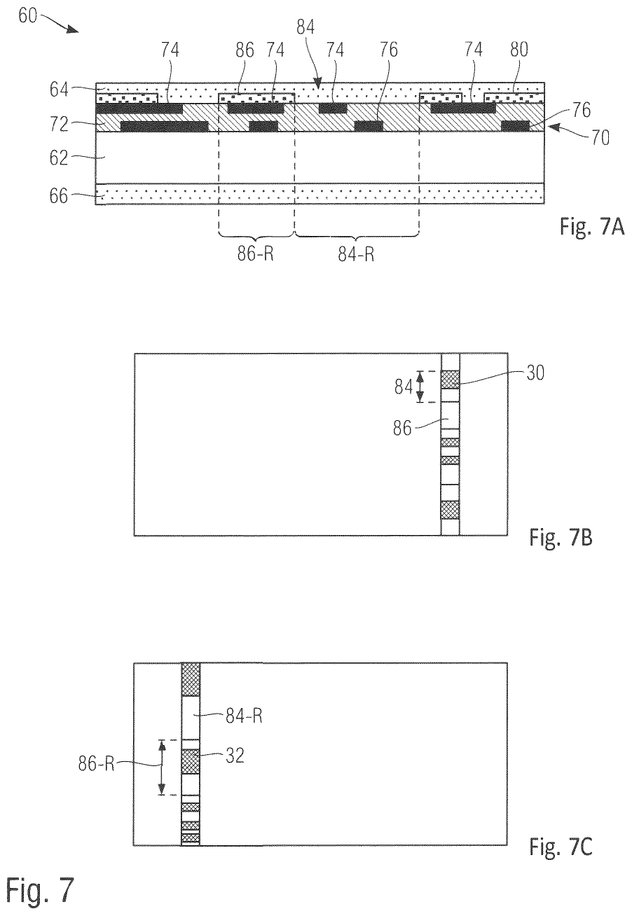

FIG. 7 shows a further exemplary embodiment of the present invention, in which the security element is not embedded in a paper banknote, but rather constitutes part of a polymer banknote 60.

With reference first to FIG. 7(a), the polymer banknote 60 includes a polymer substrate 62 that is furnished on both sides with opaque-white or ink-receiving layers 64 or 66, respectively. Between the polymer substrate 62 and the upper ink-receiving layer 64 is arranged an inventive security element 70 that includes an upper feature region 74, a lower feature region 76 and a foil layer 72 lying between the feature regions. In addition, there is imprinted on the security element 70 in some regions an IR blocker 80, such that IR web regions 86 having IR blocker 80 and IR window regions 84 without an IR blocker are created on the polymer banknote.

At least one of the feature regions 74, 76 includes a special IR substance having atypical absorption behavior, so an absorption maximum between 800 nm and 1000 nm. The other feature region can include an IR substance having typical absorption behavior, but both feature regions 74, 76 particularly preferably include the said IR substance having atypical absorption behavior.

In the exemplary embodiment in FIG. 7, the two feature regions 74, 76 are formed to be structured, but analogously to the embodiments described above, they can also be formed to be contiguous.

FIG. 7(b) shows the result of a front-side measurement of the banknote 60 with an IR sensor. In the measurement, an IR signal 30 is obtained only in the IR window regions 84, and also in the IR window regions only at the sites at which also the top-side feature region 74 having the IR substance is present. In the IR web regions 86, in contrast, due to the absorbent effect of the IR blocker 80, no IR signal is detected, also when an IR substance is present below the IR web regions.

In the reverse-side measurement in FIG. 7(c), an IR signal 32 is obtained only in the regions 86-R that lie opposite the IR web regions 86, and also in said regions 86-R, only at the sites at which the bottom-side feature region 76 having the IR substance is present. In the regions 84-R that lie opposite the IR window regions 84 in the front, in contrast, no IR signal is obtained. Analogously to the explanation for FIG. 2, the signal generation in the reverse-side measurement is currently attributed to reflections on the IR blocker 80 of the front.

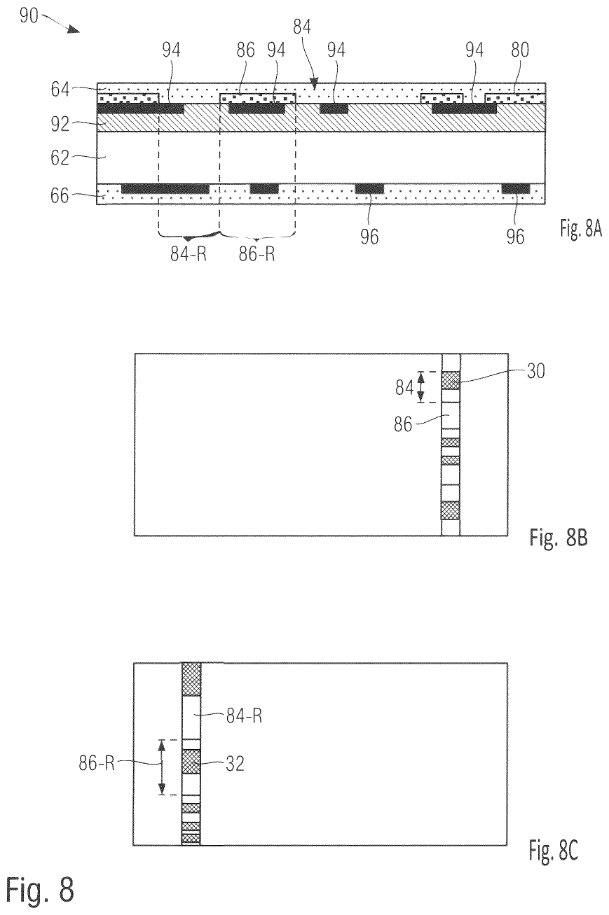

In the exemplary embodiment in FIG. 8, the security device is not formed by a security element applied to or introduced into a value document, but rather by the value document itself.

Specifically, FIG. 8(a) shows, in cross section, a polymer banknote 90 having a polymer substrate 62 that is furnished on both sides with an opaque-white or ink-receiving layer 64 or 66, respectively. On the top of the polymer substrate 62 is arranged an upper feature region 94, on the opposing bottom of the polymer substrate 62, a lower feature region 96. In addition, an intermediate layer 92 can be provided that can be formed by a foil layer or a printing layer. Furthermore, there is imprinted in some regions on the upper feature region 94 an IR blocker 80, such that IR web regions 86 having IR blocker 80 and IR window regions 84 without an IR blocker are created on the polymer banknote.

At least one of the feature regions 94, 96 includes a special IR substance having atypical absorption behavior, that is, an absorption maximum between 800 nm and 1000 nm. The other feature region can include an IR substance having typical absorption behavior, but both feature regions 94, 96 particularly preferably include the said IR substance having atypical absorption behavior.

In the exemplary embodiment, the two feature regions 94, 96 are formed to be structured, but analogously to the embodiments described above, they can also be executed to be contiguous.

FIG. 8(b) shows a front-side measurement of the polymer banknote 90 with an IR sensor. Here, an IR signal 30 is obtained only in the IR window regions 84, and also in the IR window regions only at the sites at which also the top-side feature region 94 having the IR substance is present. In the IR web regions 86, in contrast, due to the absorbent effect of the IR blocker 80, no IR signal is detected, also when an IR substance is present there below the web regions 86.

In the reverse-side measurement in FIG. 8(c), an IR signal 32 is obtained only in the regions 86-R that lie opposite the IR web regions 86, and also in said regions 86-R only at the sites at which the bottom-side feature region 96 having the IR substance is present. In the regions 84-R that lie opposite the IR window regions 84 in the front, in contrast, no IR signal is obtained.

1. A security device having a foil carrier having opposing main surfaces and having, arranged on the opposing main surfaces of the foil carrier, two machine-readable feature regions that include in each case an IR-absorbing substance, at least one of the machine-readable feature regions including an IR-absorbing substance having an absorption maximum between 800 nm and 1000 nm.

2. The security device according to claim 1, wherein both machine-readable feature regions include an IR substance having an absorption maximum between 800 nm and 1000 nm.

3. The security device according to claim 1, wherein only one of the machine-readable feature regions includes an IR substance having an absorption maximum between 800 nm and 1000 nm and the other of the machine-readable feature regions includes an IR substance without an absorption maximum between 800 nm and 1000 nm.

4. The security device according to claim 1, wherein the said IR substance that is present in at least one of the feature regions has a significantly higher absorption at a wavelength of 950 nm than at a wavelength of 850 nm, especially an at least 3%, at least 5%, or even at least 8% higher absorption.

5. The security device according to claim 1, wherein the said IR substance that is present in at least one of the feature regions has a remission of 60% or less in the wavelength range from 800 nm to 1000 nm.

6. The security device according to claim 1, wherein the two machine-readable feature regions overlap one another at least in some regions in projection.

7. The security device according to claim 1, wherein the two machine-readable feature regions form in each case a machine-readable code, in that the two machine-readable feature regions together form an additional machine-readable code.

8. The security device according to claim 1, wherein the two machine-readable feature regions are present in each case contiguously on the foil carrier.

9. The security device according to claim 1, wherein one or both of the machine-readable feature regions are present structured in the form of patterns, characters or a code.

10. The security device according to claim 1, wherein one of the machine-readable feature regions is covered in some regions with paper webs or an IR blocker.

11. The security device according to claim 1, wherein the security device is a security element, especially a security thread or a security band.

12. The security device according to claim 1, wherein the security device is a value document, especially a banknote.

13. A value document, especially a banknote, having a security device according to claim 11.

14. A method for testing a security device according to claim 1, in which the security device is impinged on with IR radiation, the IR radiation remitted by the security device is measured as an IR signal, and it is determined from the measured IR signal whether the security device includes a feature region having an IR-absorbing substance having an absorption maximum between 800 nm and 1000 nm.
